(19) United States
(12) Patent Application Publication
(10) Pub. No.: US 2020/0327766 A1
(43) Pub. Date: Oct. 15, 2020

(54) REMOTE VENDING TECHNIQUES

(71) Applicant: Space Station Limited, Denver, CO (US)

(72) Inventors: Boyd Ethan Wilkinson, Longmont, CO (US); William Troy Widgery, Denver, CO (US); Sergii Skorostetskyi, Kiev (UA)

(73) Assignee: Space Station Limited, Denver, CO (US)

(21) Appl. No.: 16/847,158

(22) Filed: Apr. 13, 2020

Related U.S. Application Data
(60) Provisional application No. 62/833,215, filed on Apr. 12, 2019.

(51) Int. Cl. G07F 11/00; G06Q 20/32; G06Q 20/38; H04W 4/021; H04W 4/35

(52) U.S. Cl. CPC G07F 11/00; G06Q 20/3223; G06Q 20/3224; H04W 4/35; G06Q 20/3278; G06Q 20/38215; H04W 4/021; G06Q 20/3276

(57) ABSTRACT

Examples of the present disclosure describe systems and methods relating to remote vending techniques. In an example, a vending device stocks one or more products to dispense to a user. A user computing device is used to communicate with a vending platform. The vending platform causes the vending device to dispense a product to the user. Since the user interacts with the vending platform and, in some instances, confirms his or her proximity to the vending device, the vending platform is able to gather and validate user information relating to the user and/or the user device. For example, the vending platform may collect a phone number, an email address, a device type, and/or a user location. Thus, such information gathered by the vending platform is usable to contact the user in the future, identify leads, and/or determine whether the vending platform assisted in converting a lead into a customer, etc.

### CROSS-REFERENCE TO RELATED APPLICATION

This application claims priority to U.S. Provisional Application No. 62/833,215, titled “Remote Vending Techniques,” filed on Apr. 12, 2019, the entire disclosure of which is hereby incorporated by reference in its entirety.

### INTRODUCTION

Vending machines provide snacks, beverages, and other products to consumers without a cashier. Due to the unattended nature of vending machines, vending machines have become a popular way to sell a wide array of products in a variety of locations. However, the direct interaction typically required by vending machines limits potential use cases and complicates the user experience.

It is with respect to these and other general considerations that the aspects disclosed herein have been made. Also, although relatively specific problems may be discussed, it should be understood that the examples should not be limited to solving the specific problems identified or discussed in this disclosure.

### REMOTE VENDING TECHNIQUES

Examples of the present disclosure describe systems and methods relating to remote vending techniques. In an example, a vending device stocks one or more products to dispense to a user. A user computing device is used to communicate with a vending platform. The vending platform causes the vending device to dispense a product to the user. Since the user interacts with the vending platform and, in some instances, confirms his or her proximity to the vending device, the vending platform is able to gather and validate user information relating to the user and/or the user device. For example, the vending platform may collect a phone number, an email address, a device type, and/or a user location. Thus, such information gathered by the vending platform is usable to contact the user in the future, identify leads, and/or determine whether the vending platform assisted in converting a lead into a customer, among other examples.

This overview is provided to introduce a selection of concepts in a simplified form that are further described below in the Detailed Description. As such, it is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an example system for practicing aspects of the remote vending techniques described herein.

FIG. 2A illustrates an example method for communicating with a user computing device to perform aspects of the remote vending techniques described herein.

FIG. 2B illustrates another example method for communicating with a user computing device to perform aspects of the remote vending techniques described herein.

FIG. 3 illustrates an example method for communicating with a vending platform to perform aspects of the remote vending techniques described herein.

FIG. 4 illustrates an example method for processing vending platform information and transaction information according to aspects described herein.

FIG. 5 illustrates an example of a suitable operating environment in which one or more of the present embodiments may be implemented.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Examples of the present disclosure describe systems and methods relating to remote vending techniques. In an example, a vending device stocks one or more products to dispense to a user. In examples, the vending device stocks only a single product. The vending device communicates with a vending platform. The vending device may periodically provide stock level indications for one or more products stocked by the vending device. In some examples, the vending device may generate an indication that a product is low on stock, thereby causing the vending platform to dispatch additional product to the vending device. It will be appreciated that, in other examples, the vending platform may evaluate a stock level indication and make a similar determination rather than the vending device providing the indication that a product is low on stock.

A user may use a user computing device to communicate with the vending platform. For example, the user communicates with the vending platform using any of a variety of communication platforms, including, but not limited to, an email message, an instant message, or a text message (e.g., short message service (SMS), multimedia messaging service (MMS), etc.). In some instances, the user uses a web browser on the user computing device in order to access a webpage associated with the vending platform and/or the vending device. As another example, an application executing on the user device is used to communicate with the vending platform according to aspects described herein. In examples, the user device may communicate directly with the vending device using Wi-Fi Direct or Bluetooth, among other examples. In some examples, the user device communicates with the vending platform over the Internet (e.g., via a wired connection, a wireless connection, etc.), such that the vending platform processes requests received from the user computing device, generates responses, and generates indications and/or relays messages to a vending device based on one or more indications that were received from the user computing device. It will be appreciated that the vending device may similarly implement such communication technologies, such that at least a part of the operations described herein with respect to the vending platform may alternatively or additionally be implemented by the vending device.

The vending platform may store payment information for a user. Accordingly, the vending platform may process a payment for a product by a user, for example in response to an indication received from the user computing device (e.g., a text message, an indication from an application, etc.). The vending platform may then generate an instruction to the vending device to dispense the product to the user. In some examples, the user device provides an indication to the vending platform that the user is proximate to the vending device. For example, the user may provide confirmation using the user device or the user device may automatically detect the presence of the vending device (e.g., via Bluetooth, near-field communication (NFC), detection of an audio signal generated by the vending device, etc.), among other examples. As used herein, “proximate” means the user and/or user device is near the vending device so as to receive or otherwise pick up a dispensed product from the vending device. For example, the user need not be in the same room as the vending device. In examples, the user may be provided with navigation instructions to locate the vending device and pick up a dispensed product.

The vending platform may allow a first user to enable a second user to dispense a product from a vending device, such that the second user need not pay for the product. As used herein, “pay-it-forward” functionality refers to such aspects. For example, payment information associated with the first user may be used to charge the first user for product dispensed for the second user. In another example, the first user may be provided with a certain quantity of free product to dispense to one or more users of his or her choosing. The second user may receive a message (e.g., text message, email message, etc.) inviting the second user to the vending platform. In examples, the second user communicates with the vending platform by responding to the message. In other examples, the second user may receive a hyperlink to a website for the vending platform or the hyperlink may enable the second user to install an application associated with the vending platform. In some instances, the second user need not join the vending platform to cause the product to be dispensed at a vending device. For example, the second user may respond to the received message or access a website using a received hyperlink, among other example interactions, to ultimately cause the vending device to dispense the product provided by the first user using the pay-it-forward functionality described herein.

In other examples, the vending platform enables a user to generate a token that is usable by a recipient to cause a vending device to dispense a product. Example tokens include, but are not limited to, a string of characters (e.g., a random sequence of letters and numbers, a set of words, etc.), a Quick Response (QR) code (or any of a variety of other barcodes, images, etc.), or a hyperlink (e.g., which may contain an identifier associated with the user, a one-time-use identifier, etc.). In some instances, the recipient may forward the token to another recipient, thereby enabling the subsequent recipient to cause the vending device to dispense product accordingly.

Thus, as a result of receiving the token, a recipient is able to provide an indication of the token to the vending platform (e.g., via SMS, email, a mobile application, etc.) in order to cause a product to be dispensed according to aspects of the present application. In examples where a hyperlink is used, a database may store a number of times the hyperlink may be used, as may be the case when the hyperlink comprises an identifier associated with a sender. In other examples where a QR code is used, a vending device may comprise an image capture device, thereby enabling the vending device to read the QR code from a user's computing device in order to cause the vending device to dispense product accordingly. As compared to pay-it-forward functionality, a token may be used to cause a vending device to dispense product without additional analysis of a user or user computing device with which the token is associated. Put another way, the token may be usable by anybody to cause a product to be dispensed. By contrast, pay-it-forward functionality may be associated with a specific user and/or user computing device (e.g., a specific phone number, specific email address, etc.), such that a pay-it-forward indication is not usable by another user, even if the initial recipient of the pay-it-forward indication forwards the indication to another recipient.

In examples, the vending device comprises a physical representation of identifying information with which a user is able to initiate communication with the vending platform. For example, a sign on the vending device may list a telephone number that the user can message. The telephone number may be a short code. In some examples, the sign further lists a string of text that the user includes when messaging the vending platform. The string of text may uniquely identify the vending device, an event at which the vending device is placed, or a geographic location or neighborhood associated with the vending device. In other examples, a QR code (or other image), NFC tag, or Bluetooth low energy beacon is used to facilitate user interaction with the vending platform. For example, an NFC tag may cause the user computing device to automatically generate a message (e.g., identifying the vending device) for transmission to the vending platform. In some instances, the device automatically transmits the message to the vending platform as a result of scanning the NFC tag (e.g., without requiring user interaction). As another example, a QR code may direct the user computing device to a website associated with the vending platform, wherein the request for the website comprises an indication of the associated vending device.

It will be appreciated that the above aspects are provided as examples and that, in other instances, additional or alternative techniques may be used. For example, a user may be instructed to send a message on a social media platform (e.g., FACEBOOK, TWITTER, INSTAGRAM, etc.). In examples, the vending platform causes the vending device to dispense product for free as a result of the user interacting with the vending platform as described above. For example, the vending device is used to dispense samples to users and collect associated user information. Further, there need not be additional interaction between the vending platform and the user computing device prior to dispensing a product. For example, a user may generate an indication to the vending platform as a result of messaging a telephone number, scanning a QR code, or scanning an NFC tag, among other examples, in response to which the vending platform may cause a vending device to dispense a product for the user. In some instances, one or more messages may subsequently be communicated to the user based on gathered user information (e.g., the following day, the following week, at a related event, etc.).

Depending on how the user interacts with the vending platform, the vending platform determines certain user information associated with the user and/or user device. For example, if the user sends a text message, the vending platform receives a phone number of the user. Similarly, if the user sends an email, the vending platform receives an email address of the user. If the user accesses a website associated with the vending platform, the vending platform may receive information relating to the user device, including, but not limited to, a device or platform type, an operating system version, and a geographic location. The vending platform may generate a user record storing user information that relates to the user and/or the user computing device. It will be appreciated that such information is provided as an example, and other information may collected and stored by the vending platform. For example, in instances where pay-it-forward functionality or token functionality is used, the user information may further comprise an association between multiple users and/or user devices of the vending platform.

As compared to other techniques that request user information and subsequently provide a product or service (e.g., a sample, access to a Wi-Fi hotspot, etc.), the user interaction resulting from aspects described herein increase the likelihood that user information received from a user and/or gathered from a user computing device is accurate and therefore usable to contact the user in the future. For example, this should make it difficult if not impossible for a user communication to originate from an inaccurate phone number or email address when communicating with the vending platform, as the user's contact information is used to communicate with the vending platform and, in some examples, for subsequent communication with the user as part of the vending interaction. Said another way, the vending platform is very likely to receive an indication from a user computing device using contact information that is, in fact, correct and valid before dispensing a product to the user. While it would certainly be possible for a sophisticated user to use cell phone redirection software to spoof or otherwise trick the platform, the systems and methods described herein should be sufficient to obtain valid contact information from a majority of typical users. Thus, if the vending device ultimately dispenses product to the user, it is possible to validate the contact information for the user.

As discussed above, the user's proximity to the vending device may be confirmed prior to dispensing product from the vending device. In other examples, additional interaction with the user may occur prior to, during, or after vending by the vending device. For example, an exchange may occur, wherein the user receives additional information (e.g., relating to a product, relating to an event, etc.) from the vending platform. In some instances, the user may be asked to answer a survey or watch a video. As a result of such aspects, the vending device may be used to distribute samples and educate users. Other techniques may use one or more employees to staff an informational booth or a giveaway, which, as compared to the remote vending techniques described herein, are more costly as a result of the associated labor cost. Further, such techniques may yield user information that is unreliable, as users may provide false information to an employee in exchange for a product. It will be appreciated that the above interactions are provided as examples and that other interactions may occur in addition or as an alternative to the above-discussed examples.

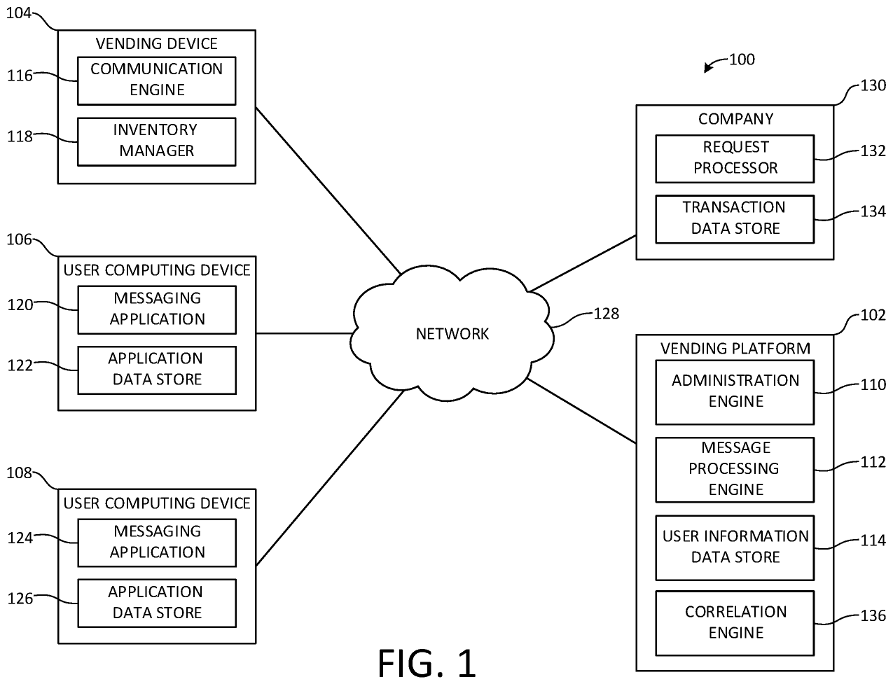

FIG. 1 illustrates an example system 100 for practicing aspects of the remote vending techniques described herein. As illustrated, system 100 is comprised of vending platform 102, vending device 104, user computing devices 106 and 108, network 128, and company 130. Vending platform 102, vending device 104, user computing devices 106 and 108, and company 130 are illustrated as communicating via network 128, which may comprise any of a variety of communication technologies. Example communication technologies include, but are not limited to, wired communication (e.g., Ethernet, USB, etc.), wireless communication (e.g., Wi-Fi, Bluetooth, NFC, infrared, a cellular network, etc.), or any combination thereof.

Vending platform 102 is illustrated as comprising administration engine 110, message processing engine 112, user information data store 114, and correlation engine 136. Administration engine 110 provides administrative functions with respect to one or more vending devices, associated users, and/or stocked products, among other examples. For example, a user that owns and/or operates a vending device may use a user device to access administration engine 110 (e.g., via a website, a mobile application, etc.). Administration engine 110 may enable the user to set product pricing, configure pay-it-forward functionality, and to configure vending platform and vending device behavior to collect and store user information (e.g., via text message, email, mobile application, etc.). Administration engine 110 may also receive stock level indications from vending device 104 and/or order additional product for vending device 104 as described above.

Message processing engine 112 is used to interact with user devices in order to vend products from vending device 104, provide additional information (e.g., in text form, as a video, etc.), and/or solicit information (e.g., using a web-based survey, an exchange of messages, etc.), among other examples. Message processing engine 112 may provide pay-it-forward functionality and/or token functionality according to aspects described herein. For example, message processing engine 112 may generate a pay-it-forward indication (e.g., to user computing device 108) in response to a received indication from a user computing device (e.g., user computing device 106). As another example, message processing engine 112 may generate a token in response to a received indication (e.g., from user computing device 106). The token may be provided to the user computing device, which may then be subsequently forwarded by the user computing device (e.g., to user computing device 108). Thus, message processing engine 112 may subsequently process received requests that are associated with pay-it-forward functionality and token functionality in order to validate such messages prior to causing vending device 104 to dispense product accordingly. In examples, message processing engine 112 processes messages via any of a variety of communication platforms, via an application, or via a website, among other examples.

Information gathered by vending platform 102 is stored in user information data store 114. For example, user information data store stores user contact information, survey responses, and user device information, among other information. User information data store 114 may also store payment information associated with users of vending platform 102, such that a user is able to easily pay for a product and cause it to be vended from vending device 104. In examples, a user record is used to store such information for a given user. In some examples, a user record may further comprise information associated with vending device 104. For example, vending device 104 may have an associated geographic location, an associated event, and/or an associated product type that may be stored as part of the user record. Such information may vary over time (e.g., vending device 104 may be located at different events, may dispense different products, etc.), such that the vending device information stored by the user record may be gathered based on the time at which product was caused to be dispensed by vending device 104. As a result of storing such information in the user record, it may be possible to perform subsequent analysis of user records (e.g., by correlation engine 136) in order to identify one or more user interests (e.g., relating to a set of events, type of products, etc.). Accordingly, subsequent messages that are sent to the user (e.g., using collected user contact information) may be selected or otherwise generated based on such identified user interests. As another example, user records may be evaluated to generate user demographic information, such as one or more geographic regions, age groups, and/or interests, among other information.

Vending device 104 is illustrated as comprising communication engine 116 and inventory manager 118. In examples, communication engine 116 communicates with vending platform 102 in order to provide stock level indications (e.g., as may be generated by inventory manager 118) and to receive vend indications to dispense one or more products. In examples, communication engine 116 communicates with a user computing device, such as user computing device 106 or user computing device 108. For example, such communication may be used to perform a proximity determination or to determine a user associated with the user computing device and perform a transaction to vend a product, among other examples. It will be appreciated that vending device 104 may receive payment information and generate/receive communication with vending platform 102 accordingly. As described above, vending device 104 may have a sign or other display (e.g., a liquid crystal or e-ink display, etc.) providing user instructions according to aspects described herein. For example, vending device 104 may display a QR code or a sequence of characters that identifies vending device 104 to vending platform 102, such that the user may use the displayed information to generate an indication (e.g., from user computing device 106 or 108) to vending platform 102 in order to dispense product as described herein. As another example, vending device 104 may comprise an image capture device (not pictured), which may scan a QR code from a user computing device. Vending device 104 may communicate with vending platform 102 to validate the scanned QR code, after which vending device 104 may dispense product accordingly. It will be appreciated that a QR code is provided as an example and that, in other examples, any of a variety of other techniques may be used to provide a token, a pay-it-forward indication, or other information to vending device 104. In some instances, communication engine 116 provides information to a user device in order to cause the user device to initiate a communication with vending platform 102. For example, vending device 104 may comprise an NFC tag, a Bluetooth low energy beacon, a Wi-Fi Access Point, or any of a variety of other communication technologies. Inventory manager 118 is used to track product stock and order additional products, among other examples.

User computing device 106 comprises messaging application 120 and application data store 122. In examples, user computing device 106 is a mobile computing device, a tablet computing device, a laptop computing device, or a desktop computing device, among other examples. As described herein, a user uses messaging application 120 to interact with vending platform 102 and to cause product to be dispensed by vending device 104. In examples, messaging application 120 is an instant messaging application, an email messaging application, or a text-messaging application, among other examples. Information displayed on vending device 104 may be used by a user of user computing device 106 to communicate with vending platform 102. In some examples, a user uses user device 106 to scan a QR code or NFC tag, thereby causing user computing device 106 to automatically generate and/or send a message to vending platform 102 as described above. User computing device 106 may install an application associated with vending platform 102 in application data store 122. Accordingly, a user of user computing device 106 may use the installed application to interact with vending platform 102 (e.g., to utilize pay-it-forward functionality, to generate tokens, to manage inventory of vending device 104, etc.). As described above, the user of user computing device 106 may answer a survey, watch a video, or perform other actions. Ultimately, the user is able to cause vending device 104 to dispense a product as a result of interacting with vending platform 102. Further, as a result of the interaction, vending platform 102 has validated user information and/or user device information relating to the user and/or user computing device 106 (which may be stored in user information data store 114).

User computing device 108 comprises similar components (e.g., messaging application 124 and application data store 126) as user computing device 106 (e.g., messaging application 120 and application data store 122). Accordingly, such aspects are not re-described. User computing device 108 is provided as an example of another user computing device with which aspects of the present application may be practiced. For example, a first user (e.g., of user computing device 106) may determine to use pay-it-forward functionality provided by vending platform 102 to share product of vending device 104 with a second user (e.g., of user computing device 108). Accordingly, the first user uses user computing device 106 to generate a pay-it-forward request to vending platform 102. The request may comprise contact information associated with the second user. The first user may use messaging application 120 or an application stored by application data store 122, among other examples. Vending platform 102 receives the request and generates a message using message processing engine 112. The generated message is provided to user computing device 108. In examples, the message is a text message or an email message, among other examples. The second user receives the generated message at user computing device 108. Accordingly, the second user is able to use user computing device 108 to ultimately cause the product shared by the first user to be vended by vending device 104.

As another example, vending platform 102 receives a request to generate a token from a user of user computing device 106. Accordingly, vending platform 102 generates a token and provides the token to user computing device 106. The user of user computing device 106 may then forward the token to a recipient, such as a user associated with user computing device 108. Accordingly, the second user is able to use the received token to cause vending device 104 to dispense product. In other examples, the second user may forward the token to yet another user computing device, such that the subsequent recipient may either use the token to cause a product to be dispensed or forward the token yet again.

System 100 is further illustrated as comprising company 130. In examples, company 130 sells one or more products comprising or otherwise associated with the product dispensed by vending device 104. In other examples, company 130 hosts an event at which vending device 104 is present. In some examples, company 130 may provide a service in addition to or as an alternative to such products and/or events. Accordingly, at least a subset of user information gathered by vending platform 102 may be associated with company 130, such that the subset of user information and/or associated determinations (e.g., relating to user interests, user demographics, etc.) may be utilized by company 130 accordingly.

Company 130 is illustrated as comprising request processor 132 and transaction data store 134. In examples, user computing device 106 or 108 is used by a user to purchase products and/or services from company 130, as may be handled by request processor 132. In some instances, the user provides billing information (e.g., a credit card number, a billing address, a contact phone number, a contact email address, etc.), which may be stored by company 130 in transaction data store 134. In other examples, a user signs up for a mailing list, creates an account, or engages in any of a variety of other interactions with company 130. Information relating to such interactions may be stored in transaction data store 134 accordingly. Thus, transaction data store 134 comprises transaction records relating to user interactions with company 130 (e.g., using user computing device 106 or 108).

As noted above, vending platform 102 further comprises correlation engine 136. In examples, correlation engine 136 processes transaction records stored by transaction data store 134 of company 130 and user records stored by user information data store 114 in order to correlate users of vending platform 102/vending device 104 and users that interacted with company 130. For example, a user record and a transaction record may be correlated according to the same or similar contact information (e.g., phone number, email address, social media network username, etc.), billing information (e.g., billing address, credit card number, etc.), and/or computing device information (e.g., the same internet protocol (IP) address, unique device identifier, one or more cookies, etc.). For example, a partial match may be used (e.g., last four digits of a credit card number, a matching first initial and full last name, etc.) and/or a confidence score may be generated based on an analysis of multiple pieces of information. In other examples, an exact match may be used (e.g., a matching email address, phone number, etc.). Thus, it will be appreciated that any of a variety of matching techniques may be used to correlate one or more user records of vending platform 102 with one or more transaction records of company 130.

In some instances, an application programming interface (API) is provided by which company 130 is able to access or otherwise query for user records associated with a specific set of transaction records. For example, company 130 may provide a set of user information from a transaction record, in response to which vending platform 102 may provide an indication as to whether any user records in user information data store 114 are associated with the set of user information, a generated set of user interests, and/or an indication of one or more events at which the user was present, among other information. It will be appreciated that any of a variety of other techniques may be used to correlate user records and transaction records. For example, company 130 may make at least a subset of the information stored by the transaction records available to vending platform 102, vending platform 102 may make at least a subset of the information stored by the user records available to company 130, or a combination thereof. Thus, as a result of the analysis performed by correlation engine 136, it may be possible to identify when a user interaction with vending platform 102/vending device 104 results in a subsequent interaction with company 130. In examples, an owner of vending device 104 may be compensated according to an attribution determination that interactions between a user and company 130 are attributable at least in part to vending device 104. Further, it may be possible to generate a set of user interests, user demographic information, and/or any of a variety of other determinations usable by company 130 to pursue sales leads, form marketing campaigns, and/or plan or revise subsequent events, product offerings, and/or service offerings, among other examples.

It will be appreciated that while system 100 is discussed above with respect to vending platform 102, vending device 104, user computing devices 106 and 108, and company 130, any number of such elements may be used in other examples. Additionally, the functionality discussed above with respect to specific aspects of system 100 are provided as examples and that, in other examples, certain functionality may be performed by other elements. As an example, vending device 104 may receive contact information from a user (or from a user device), which it may provide to vending platform 102. Vending platform 102 may generate a message using the contact information and, upon receiving a response to the generated message, instruct vending device 104 to dispense a product. Vending device 104 and/or vending platform 102 may store the received contact information accordingly.

In another embodiment, the vending device 104 may not actually dispense a product, but rather may provide some other service (e.g., display information, provide access to a restricted area, collect a user's vote, receive an item from a user, etc.) or perform some other action desired by a user, for which the platform requires or desires contact information in exchange for the service. Thus, in a broad sense the systems and methods of this disclosure are not limited to vending device or a vending service embodiment.

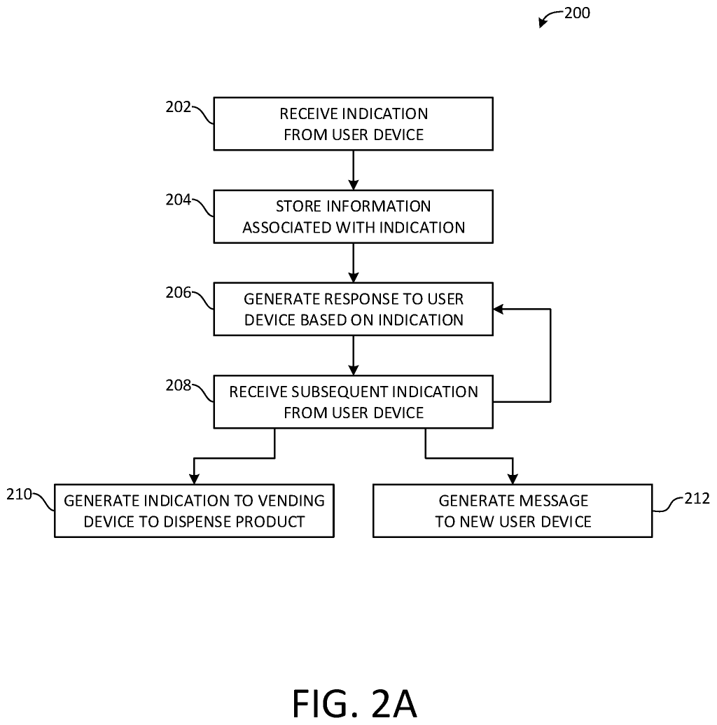

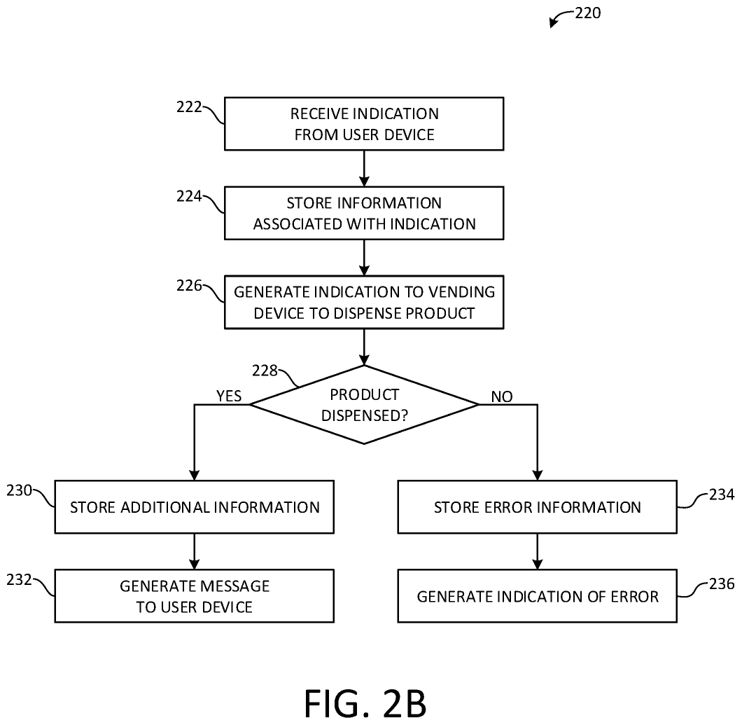

FIG. 2A illustrates an example method 200 for communicating with a user computing device to perform aspects of the remote vending techniques described herein. In examples, aspects of method 200 are performed by a vending platform, such as vending platform 102 in FIG. 1. Method 200 begins at operation 202, where an indication is received from a user computing device. In examples, the indication is received via a communication platform, via a website, or from a mobile application, among other examples. As described herein, the indication may comprise identifying information relating to a vending device, an event at which a vending device is located, an indication relating to pay-it-forward functionality, a token, etc.

At operation 204, user information relating to the indication is determined and stored. For example, a phone number associated with a text message or an email address associated with an email may be determined for the user. In other examples, user device information relating to the user device may be determined and stored. In some examples, the determined information is stored in a user information data store, such as user information data store 114 in FIG. 1. It will be appreciated that while storing user information is described as operation 204, such information may be stored as parts of other operations of method 200. For example, user information may be stored at operation 204 and, at operation 208, where a user confirms the user is proximate to a vending device, the stored user information may be marked as validated, thereby indicating that the user information was successfully used to dispense a sample to the user.

Flow progresses to operation 206, where a response to the received indication is generated and provided to the user device. In some examples, the response comprises a prompt that requests input from a user of the user device. In other examples, the response comprises a hyperlink to a webpage, a mobile application, a survey, or a video, among other examples. As an example, the response may prompt the user to confirm that they are near a vending device of the vending platform.

Moving to operation 208, a subsequent indication relating to the response generated at operation 206 is received. In examples, the subsequent indication confirms that the user is proximate to a vending device. In another example, the subsequent indication comprises a phone number, email address, or other contact information for another user with which the user of the user device would like to share a product of a vending device. An arrow is illustrated between operations 206 and 208 to indicate that a user interaction with the vending platform may be comprised of any number of exchanges. Accordingly, flow may loop between operations 206 and 208 for any amount of time. In examples, such aspects of a user's interaction is configurable using an administration engine, such as administration engine 110 in FIG. 1.

Eventually, flow may progress to operation 210, where an indication to dispense a product is provided to a vending device, such as vending device 104 in FIG. 1. In examples, flow progresses to operation 210 as a result of receiving an indication confirming that the user is proximate to the vending device. In some instances, the indication comprises a delay to be used by the vending device, thereby causing the vending device to wait before dispensing the product. The indication may comprise a message to display on a screen of the vending device and/or a sound to play on a speaker of the vending device, among other examples. Flow terminates at operation 210.

Flow may alternatively (or in some examples, additionally) progress to operation 212, where a message is generated to a new user device. In examples, where the indication received at operation 208 comprises contact information for a user referral, operation 212 generates a referral message accordingly and provides the referral message to the new user device using the contact information. For example, a phone number may be used to send a text message or an email address may be used to send an email. Accordingly, the recipient user may ultimately cause aspects of method 200 to be performed, when an indication is received from the recipient's user device at operation 202 in the future. Flow terminates at operation 212.

FIG. 2B illustrates another example method 220 for communicating with a user computing device to perform aspects of the remote vending techniques described herein. In examples, aspects of method 220 are performed by a vending platform, such as vending platform 102 in FIG. 1. Method 220 begins at operation 222, where an indication is received from a user computing device. In examples, the indication is received via a communication platform, via a website, or from a mobile application, among other examples. As described herein, the indication may comprise identifying information relating to a vending device, an event at which a vending device is located, an indication relating to pay-it-forward functionality, a token, etc.

Method 220 progresses to operation 224, where user information relating to the indication is determined and stored. For example, a phone number associated with a text message or an email address associated with an email may be determined for the user. In other examples, user device information relating to the user device may be determined and stored. In some examples, the determined information is stored in a user information data store, such as user information data store 114 in FIG. 1. It will be appreciated that while storing user information is described as operation 224, such information may be stored as parts of other operations of method 220.

At operation 226, an indication to dispense product is generated and provided with a vending device that is associated with the indication that was received at operation 222. Thus, as compared to method 200 in FIG. 2A, aspects of method 220 in FIG. 2B need not require additional user interaction (e.g., as may be the case in operations 206 and 208 of method 200) prior to causing the vending device to dispense a product. The indication may comprise a message to display on a screen of the vending device and/or a sound to play on a speaker of the vending device, among other examples.

Flow progresses to determination 228, where it is determined whether product was dispensed by the vending device. In examples, the determination comprises evaluating a response received from the vending device, where the response may indicate either a success or a failure. In some examples, the response comprises and indication of remaining inventory. The response may comprise alternative or additional vending device information, including, but not limited to, a geographic location of the vending device, an event at which the vending device is located, and/or one or more products that are stocked by the vending device. If it is determined that product was dispensed, method 220 branches “YES” to operation 230, where additional information may be stored. For example, at least a part of the vending device information may be stored in association with the user information that was stored at operation 224. In other examples, vending device information need not be received from the vending device and may instead already be available to the vending platform, such that the vending device information may be stored or otherwise associated with the user information at operation 224. Other additional information includes, but is not limited to, a timestamp, an indication that a product was successfully dispensed, and/or an indication that the product was picked up by the user.

Flow progresses to operation 232, where a message is generated and provided to the user device. In examples, the message is generated contemporaneously with causing the product to be dispensed by the vending device or, in other examples, the message is generated and provided to the user device at a later time (e.g., the next day, the following week, prior to another related event, etc.). Flow terminates at operation 232.

If, however, it is determined that a product was not dispensed at determination 228, flow instead branches “NO” to operation 234, where error information is stored. In examples, error information includes, but is not limited to, a timestamp at which the failure occurred, a vending device identifier, an associated company (e.g., company 130 in FIG. 1), and/or at least a subset of user information associated with the user and/or user device. Flow progresses to operation 236, where an indication of the error is generated. For example, a message may be generated and provided the user device indicating that the vending device was unable to dispense the product (e.g., that the device is out of stock, that the device is jammed, etc.). In some instances, the message may comprise an indication of a nearby vending device at which the user may be able to obtain the product instead. In other examples, operation 236 comprises generating an indication to another user that is responsible for the vending device, such that the other user may resolve the issue that was encountered by the vending device (e.g., ordering more product with which to stock the vending device, resolving the jam, etc.). Flow terminates at operation 236. It will be appreciated that, in other examples, aspects of method 220 may be omitted. For example, one or more operations of operations 228-236 may be omitted in some examples.

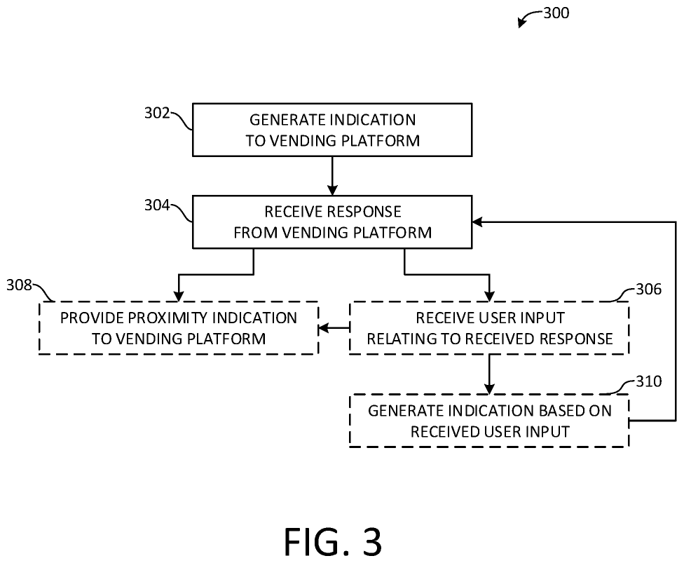

FIG. 3 illustrates an example method 300 for communicating with a vending platform to perform aspects of the remote vending techniques described herein. Method 300 may be performed by a user computing device, such as user computing device 106 or user computing device 108 in FIG. 1. Method 300 begins at operation 302, where an indication is generated and provided to a vending platform (e.g., vending platform 102 in FIG. 1). In examples, the indication is provided using a communication platform, such as via text message, using email, etc. In other examples, the indication is provided using a social media platform. For example, the user may send a “tweet” to a specified account or may post content using a specified hashtag. In some examples, the indication may be generated based on a scanned QR code or NFC tag, among other examples. For example, an NFC tag may cause the user computing device to automatically generate and/or send a text message to the vending platform according to aspects described herein. In other examples, the indication generated at operation 302 comprises a token (e.g., as may have been received from another user computing device). As another example, the indication is a response to a message that was received from the vending platform, as may have been generated based on the pay-it-forward functionality of the present application.

At operation 304, a response is received from the vending platform. In examples, the response comprises an additional prompt requesting user input from a user of the user device. As another example, the response comprises a hyperlink to a website, a video, a survey, or a mobile application for the user to install on the user device (e.g., as may be generated by a vending platform performing operation 206 of method 200 in FIG. 2A). In some instances, the response is a message that was generated as a result of the vending platform performing operation 232 or operation 236 of method 220 in FIG. 2B, after instructing the vending device to dispense a product. Operations 306-310 are illustrated using dashed boxes to indicate that, in such instances, method 300 may terminate at operation 304.

In other examples, flow may progress to operation 306, where user input is received relating to the response received from the vending platform at operation 304. In examples, the user input comprises an indication to install a mobile application via a hyperlink that was in the received response, such that subsequent aspects of method 300 may be performed using the mobile application instead of or in addition to the communication method used to originally provide the indication at operation 302. As another example, a user interacts with a webpage of a vending platform to receive additional information (e.g., messages, videos, etc.) and/or to provide subsequent input (e.g., answer a survey, refer another user, etc.). In other examples, the indication comprises text input, the selection of a photo, or any of a variety of inputs. As described above, the vending platform may request confirmation that the user is proximate to a vending device. Accordingly, the user input received at operation 306 may comprise such a confirmation.

In examples where confirmation is received, flow progresses from operation 306 to operation 308, where a proximity indication is provided to the vending platform. An additional arrow is provided from operation 304 to operation 308 to illustrate that, in some instances, the proximity indication may be automatically provided by the user device (e.g., as a result of interacting with the vending device, detecting the vending device, etc.). Thus, the vending device is caused to ultimately vend a product as described above in response to the proximity indication that is provided to the vending platform at operation 308. Flow terminates at operation 308.

In other examples, flow progresses to operation 310, where a subsequent indication is generated based on the received user input and provided to the vending platform. Accordingly, flow returns to operation 304, where a subsequent response may be received. Thus, a user may use the user device to interact with the vending platform for a variable amount of exchanges, as may be configured using an administrative engine according to aspects described herein. Flow may ultimately arrive at operation 308 where a proximity indication is provided to the vending platform, thereby causing a vending device to dispense product according to aspects described herein. Flow terminates at operation 308.

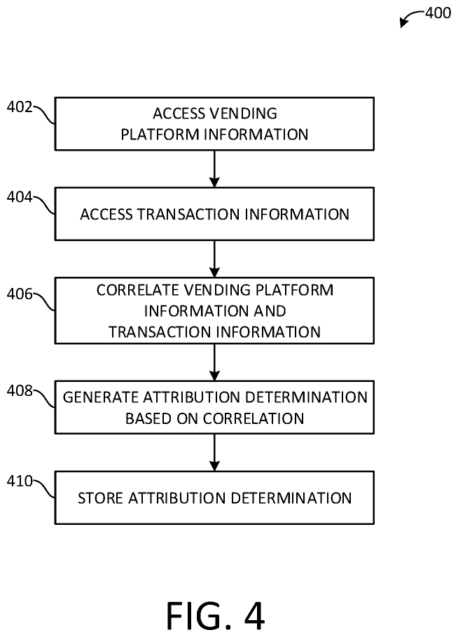

FIG. 4 illustrates an example method 400 for processing vending platform information and transaction information according to aspects described herein. In examples, aspects of method 400 are performed by a correlation engine, such as correlation engine 136 of vending platform 102 in FIG. 1. Method 400 begins at operation 402, where vending platform information is accessed. In examples, vending platform information is accessed from a user information data store, such as user information data store 114 in FIG. 1. Vending platform information comprises one or more user records, as may have been generated by users causing vending devices associated with the vending platform to dispense products according to aspects described herein. Thus, user records may comprise user information and, in some examples, associated vending device information.

Flow progresses to operation 404, where transaction information is accessed. Transaction information may be accessed from a transaction data store, such as transaction data store 134 in FIG. 1. In examples, a company (e.g., company 130 in FIG. 1) provides transaction information via an API (e.g., such that the transaction may be requested from the company using the API or may be received from a company using an API of the vending platform) or otherwise makes transaction information available for processing.

At operation 406, vending platform information and transaction platform information is correlated to identify users in common within the vending platform information accessed at operation 402 and the transaction information accessed at operation 404. For example, a user record and a transaction record may be correlated according to the same or similar contact information, billing information, and/or computing device information. For example, a partial match may be used and/or a confidence score may be generated based on an analysis of multiple pieces of information. In other examples, an exact match may be used. Thus, it will be appreciated that any of a variety of matching techniques may be used to correlate one or more user records of the vending platform information with one or more transaction records of the transaction information.

Flow progresses to operation 408, where an attribution determination is generated based on the correlation. For example, the attribution determination comprises a set of transaction records for which user records were identified within the vending platform information. Thus, the set of transaction records are attributed to the vending platform based on identifying user interactions with the vending platform that resulted in one or more subsequent interactions with the company associated with the transaction records. In some instances, the attribution determination comprises information relating to one or more vending devices associated with the user records, such as a set of geographic locations at which the devices were present, which device or devices experienced the most user interaction, and/or which product or products were the most popular, among other examples.

At operation 410, the attribution determination is stored. For example, the attribution determination may be stored for later use in determining compensation for one or more owners associated with vending device for which user records were identified to be associated with transaction records. As another example, the attribution determination (and at least a subset of information within the associated user records) may be provided to the company in order to provide demographic information. It will be appreciated that, while method 400 is described with respect to generating an attribution determination, any of a variety of other analyses may be performed in addition to or as an alternative to the attribution determination. For example, user records may be analyzed to identify a set of user interests and/or demographics. Method 400 terminates at operation 410.

It will be appreciated that example operations are described herein with respect to methods 200, 220, 300, and 400. In other examples, such operations may be omitted, modified, or reordered without departing from aspects of the present disclosure. For example, it may be not be necessary for a user's proximity to a vending device to be confirmed before causing product to be dispensed from a vending device. In such examples, a user may use a user device to provide an indication to the vending platform, such that the vending platform subsequently causes the vending device to dispense product.

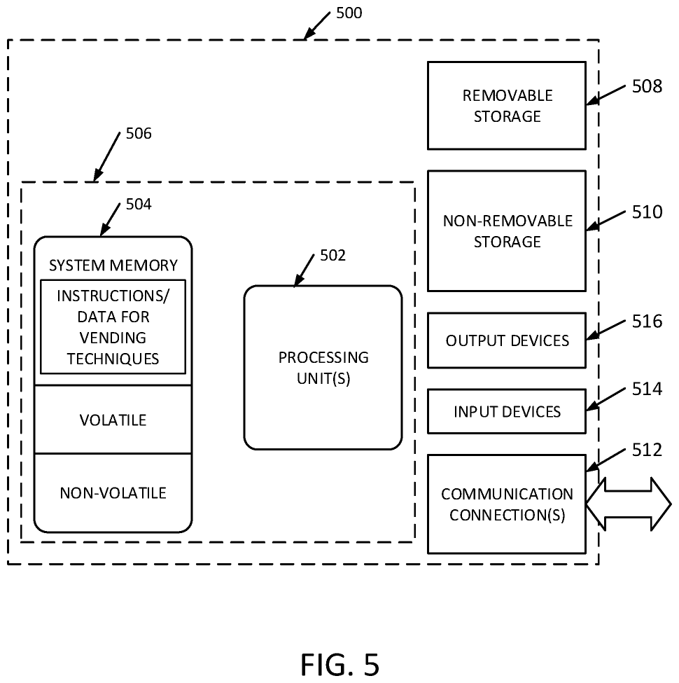

FIG. 5 illustrates one example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically includes at least one processing unit 502 and memory 504. Depending on the exact configuration and type of computing device, memory 504 (storing, among other things, user device information, user payment information, user contact information, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as keyboard, mouse, pen, voice input, etc. and/or output device(s) 516 such as a display, speakers, printer, etc. Also included in the environment may be one or more communication connections, 512, such as LAN, WAN, point to point, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a system comprising: at least one processor; and memory storing instructions that, when executed by the at least one processor, cause the system to perform a set of operations. The set of operations comprises: receiving, from a user computing device, an indication comprising identifying information relating to a vending device; generating, based on the received indication, user information associated with at least one of the user computing device or a user of the user computing device; storing the user information in a user information data store; and generating, based on the identifying information relating to the vending device, a request to the vending device to dispense a product. In an example, the indication is received from a phone number, and the stored user information comprises the phone number. In another example, the set of operations further comprises: requesting, from the user computing device, confirmation that the user computing device is proximate to the vending device; and receiving, from the user computing device, confirmation that the user computing device is proximate to the vending device. In a further example, the request to dispense the product is generated in response to receiving the confirmation that the user computing device is proximate to the vending device. In a further example, requesting confirmation from the user device comprises generating a text message to the phone number prompting a user to confirm that the user is proximate to the vending device. In yet another example, the system further comprises: the vending device, wherein the vending device comprises a physical representation of the identifying information. In a further still example, the physical representation of the identifying information comprises a Quick Response (QR) code. In an example, the physical representation of the identifying information comprises a near-field communication (NFC) tag configured to automatically generate the indication comprising the identifying information when scanned by the user computing device. In another example, the user information is further associated with vending device information in the user information data store. In a further example, the set of operations further comprises: accessing transaction information; and processing the transaction information and the stored user information to identify a transaction record associated with the user of the user computing device.

In another aspect, the technology relates to a method for causing a vending device to dispense a product. The method comprises: receiving, from a first computing device, a request to generate a token, wherein the token is usable to cause a vending device to dispense a product; providing, in response to the received request, the token; receiving, from a second computing device, an indication comprising the token; generating, based on the received indication, user information associated with at least one of the second computing device or a user of the second computing device; storing the user information in a user information data store; and generating a request to the vending device to dispense the product. In an example, received indication further comprises identifying information associated with the vending device. In another example, the user information further comprises an association between the first computing device and the second computing device. In a further example, the method further comprises receiving, from the second computing device, an indication that the second computing device is proximate to the vending device, and the request to dispense the product is generated in response to receiving the indication that the second computing device is proximate to the vending device.

In a further aspect, the technology relates to a system comprising: a vending device comprising a physical representation of identifying information associated with the vending device; and a vending platform configured to perform a set of operations. The set of operations comprises: receiving, from a user device, an indication associated with the vending device, wherein the indication comprises: the identifying information relating to the vending device; and user information associated with the user device; and in response to the received indication: storing the user information as a user record, wherein the user record further comprises vending device information associated with the vending device; and generating a request to the vending device to dispense a product. In an example, the physical representation of the identifying information comprises a near-field communication (NFC) tag configured to automatically generate the indication comprising the identifying information when scanned by the user device. In another example, the NFC tag is further configured to cause the user device to automatically transmit the generated indication. In a further example, the set of operations further comprises: accessing transaction information; and processing the transaction information and the stored user information to identify a transaction record in the transaction information that is associated with a user of the user device. In yet another example, the user information is further associated with vending device information for the vending device, and the vending device information comprises a geographic location of the vending device. In a further still example, the user information is further associated with vending device information for the vending device, and the vending device information comprises an event at which the vending device was located when the indication was received.

Aspects of the present disclosure, for example, are described above with reference to block diagrams and/or operational illustrations of methods and systems according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
receiving, from a user computing device, an indication comprising identifying information relating to a vending device;
generating, based on the received indication, user information associated with at least one of the user computing device or a user of the user computing device;
storing the user information in a user information data store; and
generating, based on the identifying information relating to the vending device, a request to the vending device to dispense a product.

2. The system of claim 1, wherein the indication is received from a phone number, and wherein the stored user information comprises the phone number.

3. The system of claim 1, wherein the set of operations further comprises:
requesting, from the user computing device, confirmation that the user computing device is proximate to the vending device; and
receiving, from the user computing device, confirmation that the user computing device is proximate to the vending device.

4. The system of claim 3, wherein the request to dispense the product is generated in response to receiving the confirmation that the user computing device is proximate to the vending device.

5. The system of claim 3, wherein requesting confirmation from the user device comprises generating a text message to the phone number prompting a user to confirm that the user is proximate to the vending device.

6. The system of claim 1, wherein the system further comprises:
the vending device, wherein the vending device comprises a physical representation of the identifying information.

7. The system of claim 5, wherein the physical representation of the identifying information comprises a Quick Response (QR) code.

8. The system of claim 5, wherein the physical representation of the identifying information comprises a near-field communication (NFC) tag configured to automatically generate the indication comprising the identifying information when scanned by the user computing device.

9. The system of claim 1, wherein the user information is further associated with vending device information in the user information data store.

10. The system of claim 1, wherein the set of operations further comprises:
accessing transaction information; and
processing the transaction information and the stored user information to identify a transaction record associated with the user of the user computing device.

11. A method for causing a vending device to dispense a product, the method comprising:
receiving, from a first computing device, a request to generate a token, wherein the token is usable to cause a vending device to dispense a product;
providing, in response to the received request, the token;
receiving, from a second computing device, an indication comprising the token;
generating, based on the received indication, user information associated with at least one of the second computing device or a user of the second computing device;
storing the user information in a user information data store; and
generating a request to the vending device to dispense the product.

12. The method of claim 11, wherein the received indication further comprises identifying information associated with the vending device.

13. The method of claim 11, wherein the user information further comprises an association between the first computing device and the second computing device.

14. The method of claim 11, wherein the method further comprises receiving, from the second computing device, an indication that the second computing device is proximate to the vending device, and wherein the request to dispense the product is generated in response to receiving the indication that the second computing device is proximate to the vending device.

15. A system comprising:
a vending device comprising a physical representation of identifying information associated with the vending device; and
a vending platform configured to perform a set of operations, the set of operations comprising:
receiving, from a user device, an indication associated with the vending device, wherein the indication comprises:
the identifying information relating to the vending device; and
user information associated with the user device; and in response to the received indication:
storing the user information as a user record, wherein the user record further comprises vending device information associated with the vending device; and
generating a request to the vending device to dispense a product.

16. The system of claim 15, wherein the physical representation of the identifying information comprises a near-field communication (NFC) tag configured to automatically generate the indication comprising the identifying information when scanned by the user device.

17. The system of claim 16, wherein the NFC tag is further configured to cause the user device to automatically transmit the generated indication.

18. The system of claim 15, wherein the set of operations further comprises:
accessing transaction information; and
processing the transaction information and the stored user information to identify a transaction record in the transaction information that is associated with a user of the user device.

19. The system of claim 15, wherein the user information is further associated with vending device information for the vending device, and wherein the vending device information comprises a geographic location of the vending device.

20. The system of claim 15, wherein the user information is further associated with vending device information for the vending device, and wherein the vending device information comprises an event at which the vending device was located when the indication was received.
